(19) United States
(12) Patent Application Publication
(10) Pub. No.: US 2005/0117540 A1
(43) Pub. Date: Jun. 2, 2005

(54) Method and apparatus for routing messages in a network

(76) Inventors: Ravi Kuchibhotla, Gurnee, IL (US); Niels Peter Skov Andersen, Roskilde (DK); Stephen A. Howell, Gloucester (GB)

Correspondence Address: MOTOROLA INC, 600 NORTH US HIGHWAY 45, ROOM AS437, LIBERTYVILLE, IL, 60048-5343, US

(21) Appl. No.: 10/680,662

(22) Filed: Oct. 7, 2003

(51) Int. Cl. H04Q 7/00; G06F 15/177; G06F 15/16

(52) U.S. Cl. 370/329; 709/222; 709/227

(57) ABSTRACT

A method of routing a message in a network includes transmitting by a mobile station (105) a signaling connection establishment message (308) on a radio connection to a radio network controller (102) though a base station (104). The signaling connection establishment message can include a registration request message. Next the mobile station can receive a registration accept message (310) on the radio connection and can subsequently transmit an uplink signaling message (312) on the radio connection. The uplink signaling message from the mobile station can include a core network operator identifier (604).

### CROSS-REFERENCE TO RELATED APPLICATIONS

This application is related to application entitled “APPARATUS AND METHOD FOR SHARED NETWORK,” Motorola case number CS23736RL, filed on even date herewith and commonly assigned to the assignee of the present application and which is hereby incorporated by reference.

This application is also related to application entitled “METHOD FOR SELECTING A CORE NETWORK,” Motorola case number CS23737RL, filed on even date herewith and commonly assigned to the assignee of the present application and which is hereby incorporated by reference.

This application is also related to application entitled “WIRELESS ACCESS NETWORK SHARING AMONG CORE NETWORKS AND METHODS,” Motorola case number CS23738RL, filed on even date herewith and commonly assigned to the assignee of the present application and which is hereby incorporated by reference.

### BACKGROUND

1. Field

The present disclosure is directed to a method and an apparatus for routing messages in a network and more particularly to routing a message to a desired core network.

2. Description of Related Art

Presently, wireless communication systems in general include a radio access network (RAN) and a core network (CN). The access independent part of a network is known as the core network. In some mobile communication networks, the core network includes a mobile switching center, a packet data network and other network entities. In other types of networks, similar network entities are present and perform similar tasks such as routing calls, packet sessions, etc. User equipment, also known as mobile stations (MS) in the case of wireless networks, access the network through the access dependent part of the network, known as access network (AN). In one type of wireless communication networks using radio frequency (RF) signals, the AN is known as the radio access network (RAN). The RAN includes a radio network controller (RNC) or base station controller (BSC) and base stations or Node Bs. The RAN manages the wireless communication links between the base stations and the mobile stations. The CN receives messages from the public switched telephone network (PSTN), other mobile stations, and other core networks and core network entities and passes them to the mobile stations through the RAN.

In current networks, the RAN and the CN are configured such that one radio access network is connected to only one core network. This means that the RAN and the CN are able to use the same network identity or public land mobile network (PLMN) identity, where the PLMN identity is broadcast by the RAN and identifies the network, both the radio access network and the core network. The mobile station therefore only needs to select the RAN and a separate selection of the CN operator is unnecessary.

Emerging wireless communication technologies allow network operators to share resources. One example of network sharing is to share the radio access network resources by allowing multiple core networks operated typically by different service providers or operators to couple to the radio access network. The RAN is connected to the multiple core networks by a radio network controller (RNC). The radio network controller controls the radio resources, such as the base stations. This allows multiple service providers to use one radio access network and the same limited number of frequency bands. However, the system cannot accommodate multiple system operators to ensure that certain information from a MS is directed to the proper core network, system operator, or service provider. In the emerging universal mobile telephone system (UMTS), the routing of messages is either to a packet switched domain or circuit switched domain and not by system operator. Multiple service provider routing, or routing to the appropriate core network is not possible as there is only one system operator for both the radio network and the core network. In a shared RAN, multiple core network operators share the radio infrastructure and/or radio frequencies and thus messages must be routed to the proper core network as the RAN is now associated with multiple core network operators.

Thus, there is a need for a method of message routing where a plurality of core networks controlled by different operators is coupled to a single access network. This access network may be a radio access network or any other access network.

### BRIEF DESCRIPTION OF THE DRAWINGS

The embodiments of the present disclosure will be described with reference to the following example figures, wherein like numerals designate like elements, and wherein:

FIG. 1 is an exemplary diagram of a wireless communication system of the present disclosure according to one embodiment;

FIG. 2 is an exemplary circuit block diagram of the present disclosure according to one embodiment;

FIG. 3 is an exemplary flow chart illustrating messages routing of the present disclosure according to one embodiment;

FIG. 4 is an exemplary flow chart illustrating messages routing of the present disclosure according to another embodiment;

FIG. 5 is an exemplary flow chart illustrating messages routing of the present disclosure according to another embodiment; and

FIG. 6 is an exemplary diagram of messages of the present disclosure according to one embodiment.

### DETAILED DESCRIPTION OF THE DRAWINGS

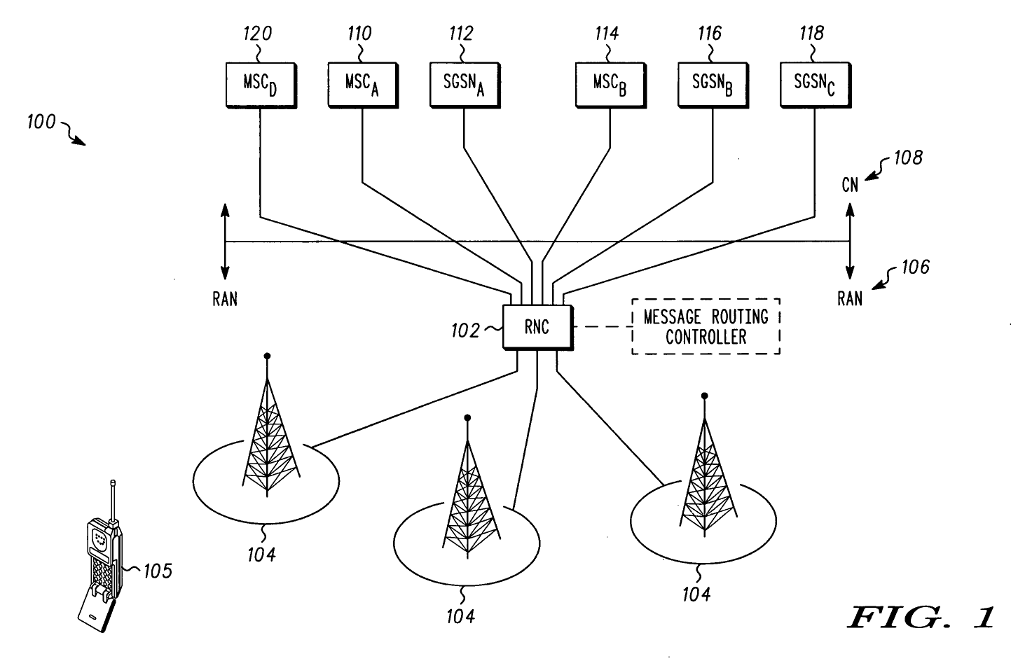

FIG. 1 is an exemplary diagram of a wireless communication system 100 according to the present disclosure. The system 100 includes a radio network controller (RNC) 102, at least one base station 104, and a mobile station (MS) 105. The radio network controller 102 may also be a base station controller (BSC) which is coupled to at least one transceiver such as a base station 104 or wireless access point or the like. The RNC 102 and the base stations 104 form the radio access network (RAN) 106 portion of the system. Multiple core networks are connected to the radio access network 106. A first core network, which is coupled to the RAN 106, includes a mobile switching center (MSC), and a serving GPRS support node (SGSN). The core network (CN) 108 portion of the system, illustrated in FIG. 1, includes a first MSC 110 and a first SGSN 112 for a first service provider. A second core network includes a second MSC 114 and a second SGSN 116 for a second service provider. The core network 108 can also include other MSC's 120 and other SGSN's 112. It is understood by one skilled in the art that any number of core networks may be coupled to a RAN 106. In addition it should be noted that a wireless local area network can also form the radio access network, in which case a wireless local area network access point takes the place of the base station in the radio access network. It should also be noted that the system 100 is not limited to wireless communication and that the system 100 may be a land-based communication system. The SGSN 112 may also be a packet data network or the like.

Although the embodiment illustrated in FIG. 1 shows a universal mobile telephone system (UMTS) network, the present disclosure may apply to other wireless communication systems such as code division multiple access (CDMA) systems, i.e. IS-95 related and cdma2000, global standard for mobile communication (GSM) and other time division multiple access systems, wireless local area networks (WLAN) systems or the like.

Mobile stations accessing the network through other wireless access networks such as through WLAN would use the WLAN access point similar to the RAN. WLAN currently operates under the 802.11 standards also known as WiFi but the access points are not limited to this technology. In this exemplary embodiment, the WLAN is coupled to multiple core networks. It can be a dedicated connection or through the internet or a combination of other connections. The WLAN broadcasts the service set identifier (SSID) instead of a PLMNid. The SSID identifies an individual WLAN access point and the MS 105 will register to the core network(s) that the WLAN is connected to. The MS 105 will either receive a registration accept message or receive a list of sharing networks in the registration reject message or similar negotiation procedure. The list of allowed SSID may be something stored in the terminal or in the SIM or USIM or similar such application.

In FIG. 1, the MS 105 first attempts to form a communication link with at least one of the base stations 104 of the RAN 106. The MS 105 in the exemplary embodiment is also configured to operate with at least one of the core network operators, typically the service provider from which the subscriber purchased the service. In current mobile networks, a MS 105 is programmed to tune to a certain predetermined frequency or set of frequencies. The core network operator, or service provider, through the RNC 102 and each base station 104, transmits a core network identifier or a public land mobile network identity (PLMNid) that identifies the core network. The PLMNid may include at least a mobile country code and a mobile network code. The core network identifier may identify the service provider associated with the core network. The MS 105 also has a list of PLMN identities (PLMNid's) of one or more preferred core network operators stored either in the MS 105 or on a SIM card (not shown) coupled to the MS 105. When the MS 105 receives a signal having the same PLMNid that matches a PLMNid that is stored in the MS memory or SIM, the MS 105 attempts to connect to or register with the core network associated with the selected PLMNid. When the MS 105 finds a signal on a frequency with a PLMNid that is not stored in the MS 105 or SIM, it may attempt to connect to or register with the core network associated with that PLMNid. The MS 105 of the present disclosure may or may not have stored a matching PLMNid of that being broadcast by the RAN 106 and the MS 105 will attempt to register on the network identified by the PLMNid broadcast by the RAN 106.

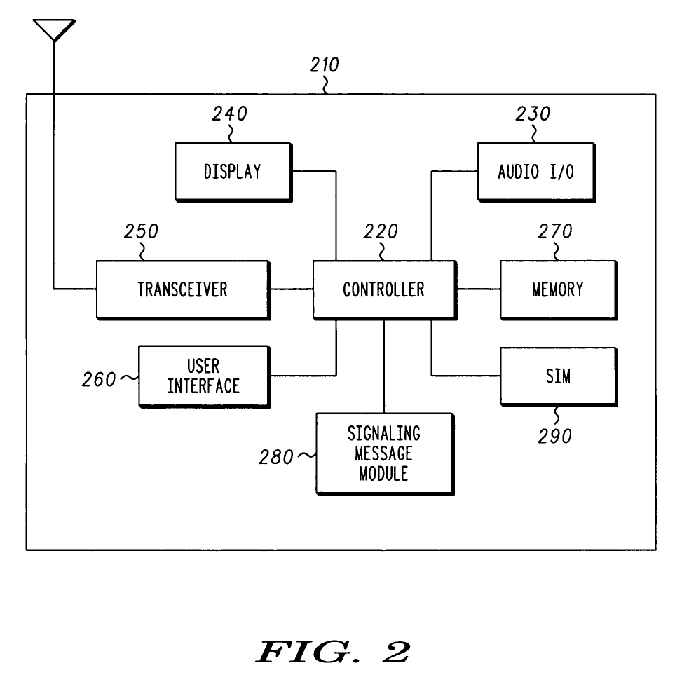

FIG. 2 is an exemplary block diagram of a MS 105, such as a UMTS terminal, according to one exemplary embodiment. The MS 105 may include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, and a memory 270 coupled to the housing 210. A signal message module 280 can be coupled to the controller 220. The signal message module 280 may be hardware coupled to the controller 220 or software located in the memory 270 and executed by the controller 220. The memory 270 can include a core network operator ID or the list of core network operator identifiers may be stored in a subscriber identity module (SIM) 290 or Universal Subscriber Identity Module (USIM).

Continuing with FIG. 2, the display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory, a SIM, or any other memory that can be coupled to a mobile communication device.

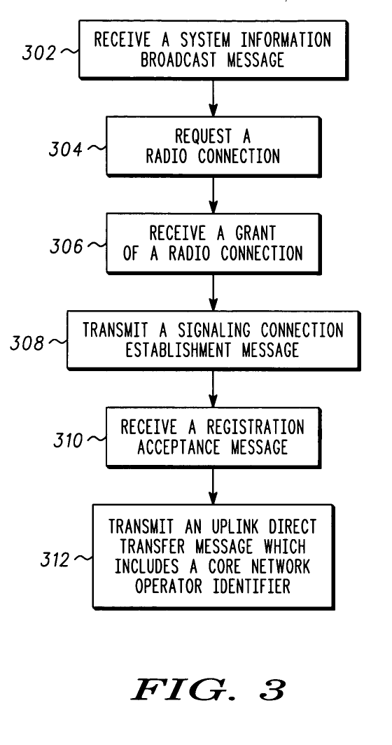

In one exemplary embodiment shown in FIG. 3, an exemplary flow diagram illustrates the message routing method of the present disclosure. The MS 105 receives a system information broadcast message 302. Upon receiving the system information broadcast message, the MS 105 requests 304 a radio connection. In one exemplary embodiment, the radio connection is requested by the MS 105 transmitting a radio connection request message. Next the MS 105 receives a grant of the radio connection 306 by the RNC 102. A radio connection or communication link has been established between the MS 105 and the base station 104. Establishing a connection between a MS 105 and a base station 104 is known to those skilled in the art and can be achieved in multiple fashions.

Next the MS 105 will use the established communication link or connection to attempt to register with a core network 108. The MS 105 transmits 308 a signaling connection establishment message over the radio connection. The signaling connection establishment message may include a desired core network operator identifier. In response to the transmission of the signaling connection establishment message 308, the MS 105 will receive a registration accept message 310 over the radio connection. This message may include an assigned core network operator identifier. In response to the MS 105 receiving the registration accept message 310, the MS 105 will transmit a signaling message that includes the desired core network operator identifier, the assigned core network operator identifier or an equivalent thereof. This includes all subsequent messages to the registered core network, or non-access stratum (NAS) messages 312, all including either the desired core network operator identifier, the assigned core network operator identifier or an equivalent thereof.

In one embodiment, the desired core network operator identifier is a desired PLMNid and the assigned core network operator identifier is an assigned PLMNid. One equivalent of the core network identifier may also be a coded identifier that is equivalent to the desired core network operator identifier or the assigned core network operator identifier that is smaller in size.

In one exemplary embodiment, the MS 105 transmits the desired core network identifier in the signaling connection establishment message to the RNC 102. In response, the MS 105 will receive the registration accept message 310 without an assigned core network operator identifier. The MS 105 will then transmit all subsequent NAS messages with the desired core network operator identifier.

In another exemplary embodiment, the MS 105 transmits the desired core network identifier in the signaling connection establishment message to the RNC 102. In response, the MS 105 will receive the registration accept message 310 with an assigned core network operator identifier. The MS 105 will then transmit all subsequent NAS messages 312 with the assigned core network operator identifier. The assigned core network operator identification may be the same as the as the desired core network operator identification.

In yet another exemplary embodiment, the MS 105 transmits the signaling connection establishment message 308 without the desired core network identifier to the RNC 102. In response, the MS 105 will receive the registration accept message 310 with an assigned core network operator identifier. The MS 105 will then transmit all subsequent NAS messages 312 with the assigned core network operator identifier. For example the MS 105 is a roaming mobile such that it does not recognize PLMN identifiers broadcast by the RAN and therefore may be assigned by the network to any of the core networks coupled with the RAN.

It is not necessary that the core networks be coupled to wireless networks such as the RAN. The network may be a wired network such as wireline, cable, or the like. Wireline devices such as home phones may access any of the many wireline operators who are all sharing the wire connection to the home.

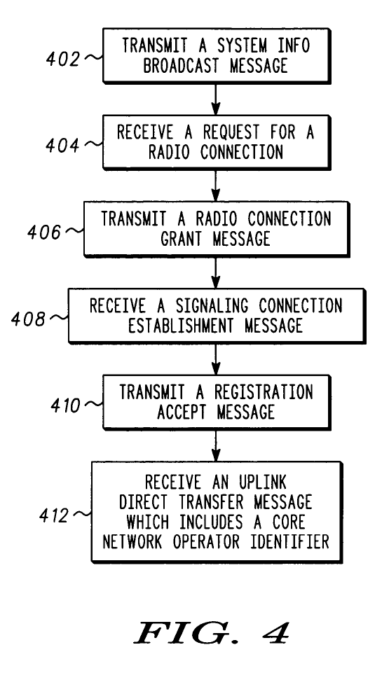

Moving to FIG. 4, a flow diagram is shown outlining the message routing at the RNC102. In the first step, the RNC 102 transmits a system information broadcast message 402. Once a MS 105 receives and responds to the system information broadcast message, the RNC 102 receives a radio connection request 404. Next the RNC 102 transmits a grant of the radio connection 406 to the MS 105. A radio connection or communication link has been established between the MS 105 and the RNC 102 through the base station 104.

When the MS 105 attempts to register with a core network 108, the RNC 102 will receive a signaling connection establishment message 408 over the radio connection from the MS 105. The signaling connection establishment message may include a desired core network operator identifier as discussed above. In response to receiving the signaling connection establishment message 408, the RNC 102 will transmit a registration accept message 410, that may be received from the registration accepting core network, over the radio connection. This message may include an assigned core network operator identifier. The RNC 102 will then receive all subsequent messages to the registered core network, or non-access stratum (NAS) messages 412 which include either the desired core network operator identifier, the assigned core network operator identifier or an equivalent thereof. The RNC 102 uses the included information to route the message to the identified core network.

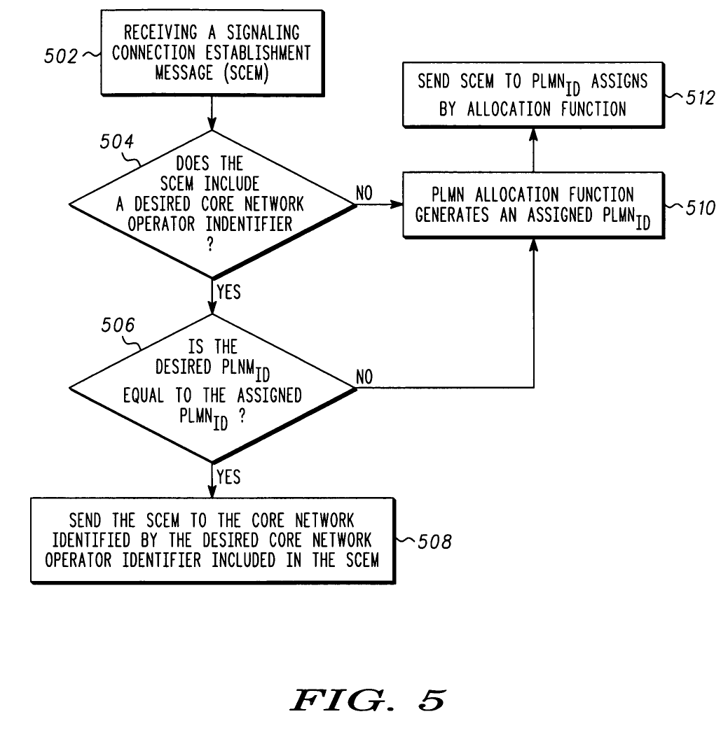

The MS 105 will transmit the signaling connection establishment message either with, or without a desired core network operator identifier. In an exemplary embodiment where the desired core network operator identifier is transmitted, the signaling connection establishment message is then routed to the desired core network by a router. The router is either in the RNC 102 and a part of the RNC 102 functionality or a separate node, which is a part of the network. For example, the router is coupled to the RNC 102 or in between the RNC 102 and the multiple core networks. FIG. 5 illustrates the routing of the signaling connection establishment message received from the MS 105. In one exemplary embodiment the RNC 102 receives 502 the signaling connection establishment message. The RNC 102 determines that the signaling connection establishment message includes a desired core network operator identifier 504. If the signaling connection establishment message does include the desired core network operator identifier, the RNC 102 then determines 506 if the desired core network operator identifier is to be the assigned core network operator identifier. If the desired core network operator identifier is to be the assigned core network operator identifier, then the RNC 102 sends 508 the signaling connection establishment message to the identified core network.

If the desired core network operator identifier is determined 504 not to be the assigned core network operator identifier, then the RNC 102 routes the signaling connection establishment message to the core network identified by the assigned core network operator identifier. The assigned core network operator identifier may be generated by a PLMN allocation function. The PLMN allocation function generates 510 a core network operator identifier in accordance with predetermined criteria determined by the network operators or service providers. The RNC 102 sends 512 the signaling connection establishment message to the core network associated with the PLMNid assigned and generated 510 by the allocation function.

In another exemplary embodiment, the RNC 102 receives the signaling connection establishment message and determines 504 that the signaling connection establishment message does not include a desired core network operator identifier. Then the RNC 102 executes a PLMN or core network allocation function to generate 510 and assign a PLMNid associated with a core network operator identifier. The RNC 102 will then send 512 the assigned core network operator identifier determined by the PLMN allocation function to the core network identified by the assigned core network operator identifier. The use of the RNC 102 to route the signaling connection establishment message is one example. The route determination can be determined in a separate module aside from the RNC 102 or other parts of either the RAN 106 or CN 108.

In this embodiment, the RNC 102, or RNC equivalent, which is connected to a plurality of core networks, and will select which core network to send the registration request message to with the allocation function. The allocation function, which may reside in the RNC 102, may assign the PLMNid based on predetermined settings, by randomly selecting the core network to receive the registration request or the RNC may select the core network in a round robin manner or by the indicated domain identity such as the packet domain or circuit switched domain.

In one exemplary embodiment both the desired core network operator identifier or the assigned core network operator identifier can be correlated to a PLMN code. The PLMN code correlates to a unique PLMN identity. In one exemplary embodiment the PLMN code is shorter than the complete PLMN identifier, for example the desired core network operator identifier or the assigned core network operator identifier. This code can be assigned by the RNC 102 or the core network that is accepting the registration. In one embodiment, the PLMN code is assigned within the registration accept message. In another embodiment the PLMN code is assigned by the network when forwarding the registration accept message to the MS 105.

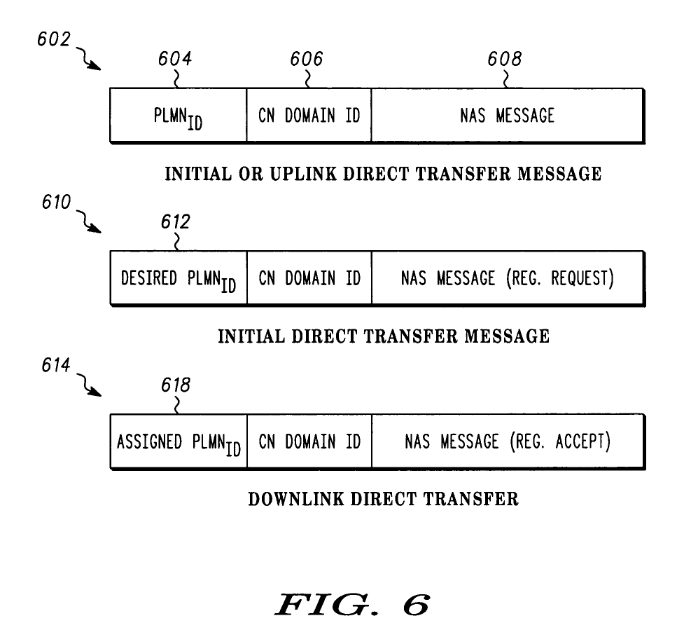

FIG. 6 illustrates code or message segments of the present disclosure. The communications device communicates with the core network through signaling messages. In one exemplary embodiment, the signaling message is carried in a direct transfer message. In particular FIG. 6 illustrates a direct transfer message (DTM) 602. This direct transfer message is an signaling message that may be an uplink DTM or a downlink DTM. The DTM 602 may include a PLMNid 604, a CN domain identity 606 and a NAS message 608. The PLMNid 604 includes the core network operator identifier. The CN identity 606 in one embodiment identifies whether the NAS message is a message directed towards the circuit switched domain or a packet switched domain. The PLMNid may also be a PLMN code, which is representative of the PLMNid. In one embodiment the PLMN code is shorter than the PLMNid.

In one exemplary embodiment, the DTM 610 includes the desired core network operator identifier 612. This may be a desired PLMNid in one exemplary embodiment. In this embodiment, the MS 102 can send the DTM 610 with the desired core network operator identifier as discussed above. The RNC 102 can then send a DTM 614 with an assigned PLMNid 618 or an assigned core network operator identifier, in the registration accept message, for example.

Referring back to FIG. 1, a MS 105 may register on different core network operators to obtain service on the different core network domains. For example, a first core network may be capable of packet switched services and second core network may be capable of circuit switched services. The MS 105 may therefore send packet switched information to the first core network and the circuit switched information to the second core network. This may be achieved by including the appropriate PLMNid or PLMN code in the DTM along with the CN domain identity which identifies either the circuit switched or packet switched network.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention.

1. A method in a communication device, comprising:
transmitting a signaling connection establishment message on a radio connection, the signaling connection establishment message including a registration request message;
receiving a registration accept message on the radio connection; and
transmitting an uplink signaling message on the radio connection, the uplink signaling message including a core network operator identifier.

2. The method according to claim 1, wherein the uplink signaling message comprises a non-access stratum signaling message.

3. The method according to claim 2, wherein the uplink signaling message includes a domain identity.

4. The method according to claim 3, wherein the domain identity comprises at least one of a packet switched domain indicator and a circuit switched domain indicator.

5. The method according to claim 1, wherein the signaling connection establishment message comprises an initial core network signaling message.

6. The method according to claim 1, wherein the registration request message includes a desired core network operator identifier.

7. The method according to claim 1, wherein the registration accept message includes an assigned core network operator identifier.

8. The method according to claim 1, wherein the core network operator identifier comprises a public land mobile network identity including a mobile country code and a mobile network code.

9. A method in a mobile communication device, comprising:
receiving a system information broadcast message;
requesting a radio connection;
receiving a grant of a radio connection;
transmitting a signaling connection establishment message on the radio connection, the signaling connection establishment message including a registration request message;
receiving a registration accept message on the radio connection; and
transmitting an uplink signaling message on the radio connection, the uplink signaling message including a core network operator identifier.

10. The method according to claim 9, wherein the uplink signaling message comprises a non-access stratum signaling message.

11. The method according to claim 10, wherein the signaling connection establishment message comprises an initial core network signaling message.

12. A method for routing messages in a network, comprising:
receiving radio connection request message;
sending a radio connection grant message;
receiving a signaling connection establishment message including a registration request message;
sending a registration accept message; and
receiving an uplink signaling message, the uplink signaling message including a core network operator identifier.

13. The method according to claim 12, further comprising determining whether the mobile communication device can receive a core network operator identifier in a registration accept message.

14. The method according to claim 12, further comprising sending a registration denial message, the registration denial message including a forbidden core network operator identifier.

15. The method according to claim 12, further comprising sending a radio system broadcast message.

16. The method according to claim 12, wherein the uplink signaling message comprises a non-access stratum signaling message.

17. The method according to claim 16, wherein the uplink signaling message includes a domain identity.

18. The method according to claim 17, wherein the domain identity comprises at least one of a packet switched domain indicator and a circuit switched domain indicator.

19. The method according to claim 12, wherein the signaling connection establishment message comprises an initial core network signaling message.

20. The method according to claim 12, wherein the registration request message includes a desired core network operator identifier.

21. The method according to claim 12, wherein the registration accept message includes an assigned core network operator identifier.

22. The method according to claim 12, wherein the core network operator identifier comprises a public land mobile network identity including a mobile country code and a mobile network code.

23. The method according to claim 12, further comprising:
forwarding the non-access stratum signaling message to a first core network operator when the non-access stratum signaling message is a circuit switched message; and
forwarding the forwarding the non-access stratum signaling message to a second core network operator when the non-access stratum signaling message is a packet switched message.

24. A mobile communication device, comprising:
a transceiver;
a controller coupled to the transceiver, the controller configured to control the operations of the mobile communication device; and
a signaling message module coupled to the controller, the signaling message module configured to transmit a signaling connection establishment message on a radio connection, the signaling connection establishment message including a registration request message, receive a registration accept message on the radio connection, and transmit an uplink signaling message on the radio connection, the uplink signaling message including a core network operator identifier.

25. The mobile communication device according to claim 24, wherein the uplink signaling message comprises a non-access stratum signaling message and a domain identity, the domain identity comprising at least one of a packet switched domain indicator and a circuit switched domain indicator.

26. The mobile communication device according to claim 25, wherein the signaling connection establishment message comprises an initial core network signaling message.

27. A method for routing messages in a network, comprising:
receiving radio connection request message;
sending a radio connection grant message;
receiving a signaling connection establishment message including a registration request message;
selecting a core network from a plurality of core networks to process the registration message; and
sending a registration accept message.

28. The method in claim 27, wherein the selecting step includes,
selecting a core network from a plurality of core networks in a random manner.

29. he method in claim 27, wherein the selecting step includes,
selecting a core network from a plurality of core networks in a round robin manner.

30. The method in claim 27, wherein the selecting step includes,
selecting a core network from a plurality of core networks for an indicated domain identity.

31. A method in a mobile communication device, comprising:
receiving a system information broadcast message;
transmitting a signaling connection establishment message, the signaling connection establishment message including a registration request message;
receiving a registration accept message; and
transmitting an uplink signaling message, the uplink signaling message including a core network operator identifier.

32. The method according to claim 31, wherein the uplink signaling message includes a domain identity, the domain identity comprising at least one of a packet switched domain indicator and a circuit switched domain indicator.

33. A method in a communication device, comprising:
transmitting a signaling connection establishment message on a connection, the signaling connection establishment message including a registration request message;
receiving a registration accept message on the connection; and
transmitting an uplink signaling message on the connection, the uplink signaling message including a core network operator identifier.

34. The method according to claim 33, wherein the uplink signaling message comprises a non-access stratum signaling message.

35. The method according to claim 34, wherein the uplink signaling message includes a domain identity.

36. The method according to claim 35, wherein the domain identity comprises at least one of a packet switched domain indicator and a circuit switched domain indicator.

37. The method according to claim 36, wherein the signaling connection establishment message comprises an initial core network signaling message.

38. The method according to claim 33, wherein the registration request message includes a desired core network operator identifier.

39. The method according to claim 33, wherein the registration accept message includes an assigned core network operator identifier.
